(19) United States
(12) Patent Application Publication
(10) Pub. No.: US 2010/0295662 A1
(43) Pub. Date: Nov. 25, 2010

(54) VERIFICATION UNIT FOR CONDUCTING A TIME-RELATED VALIDITY CHECK

(76) Inventors: Peter Hagl, Wien (AT); Markus Moser, Graz (AU); Martin Pelzmann, Graz (AU); Alfred Pohl, Mistelbach (AU); Matthias Zimmermann, Wien (AU)

Correspondence Address: BRINKS HOFER GILSON & LIONE, P.O. BOX 10395, CHICAGO, IL, 60610, US

(21) Appl. No.: 12/669,925

(22) PCT Filed: Jun. 19, 2008
(86) PCT No.: PCT/EP2008/057781

§ 371 Date: Jun. 8, 2010

(30) Foreign Application Priority Data
Jul. 24, 2007 (DE) 10 2007 034 528.5

(51) Int. Cl. H04Q 5/22

(52) U.S. Cl. 340/10.1

(57) ABSTRACT

The present embodiments relate to checking a validity of a time-limited status of a device. In one embodiment, a checking unit includes an RFID reader and a control unit. The control unit is embodied for performing a validity check that relates to a time period and is based on time information read by the RFID reader from an RFID label and conveyed to the control unit.

The present patent document claims the benefit of PCT Application Serial Number PCT/EP2008/057781, filed Jun. 19, 2008, which is hereby incorporated by reference. This patent document also claims the benefit of DE 10 2007 034 528.5, filed Jul. 24, 2007, which is also hereby incorporated by reference.

### BACKGROUND

The present embodiments relate to conducting a validity check relating to a time period, in particular a check of maintenance intervals.

In an age of increasing technical complexity and growing dependency on technology, individuals depend on the technology they employ. Objects and technical devices are subject to ageing, the result of which is that functioning capability will be adversely affected or disrupted at a certain age. Technical devices may be subject to regular checks for proper functioning. Any shortcomings may be rectified, which may be referred to as “maintenance”.

Maintenance intervals are usually stipulated on a device-specific basis. Monitoring of the devices and checking compliance with the maintenance intervals is customarily carried out by suitably trained personnel. Given the growing complexity of an increasingly mechanized world, the mounting work load placed on individuals, and the errors to which humans as a biological system are prone, it is often desirable to provide the maintenance personnel as far as possible with aids that will obviate omissions and errors. When the hazard potential is high it would even be desirable for an improperly maintained machine to be prevented from being operated.

### SUMMARY AND DESCRIPTION

The present embodiments may obviate one or more of the drawbacks or limitations inherent in the related art. For example, the present embodiments may relate to improved compliance with maintenance times or checking times specified for technical devices.

In one embodiment, a checking unit includes a radio frequency identification (RFID) reader and a control unit, with the control unit being embodied for performing a validity check that relates to a time period and is based on time information read by the RFID reader from an RFID label or RFID tag and conveyed to the control unit. An RFID system is accessed, or time information stored in an RFID label is retrieved, in order to perform a validity check. The “checking unit” may be a functional unit but not necessarily physical unit.

RFID technology may be employed for realizing an automatic validity check. RFID is an abbreviation of the term “Radio Frequency Identification”. RFID is a method for automatically identifying objects and living things. Apart from contactlessly identifying the location of objects, RFID is used also for automatically registering and storing data. An RFID system may include a transponder for a reader for reading out information stored on the transponder and RFID middleware having interfaces for forwarding the information that has been read or further processing the information. The transponder may include a microchip, an antenna, and a support or housing. Active transponders additionally have an energy source. The difference between active and passive transponders is that passive transponders do not have a separate energy source and are instead powered by the energy conveyed via the reader. The RFID transponder is also referred to below by one of the customary terms “RFID label” and “RFID tag”, whose names derive from the customarily employed form of the support or housing.

An RFID reader can be employed to obtain time information that can be used for a validity check relating to a time period. The time information is, for example, a time when a device needs further checking or maintenance. The time information can also be the length of time for which a device's function check is valid. The validity check is, for example, a check to determine whether maintenance is due again or, in the case of certification or confirmation of the functional status, whether the relevant time period has or has not expired. Reading the time information and checking the validity can be performed at regular intervals, for example, but those procedures are alternatively coupled to operations performed on the device being examined, for example, power-up or cutover. The time information can also take such operations into account and delimit the length of the interval between individual checks by means of an electronic operating-hours counter, start-up counter, etc.

The checking unit simplifies checking whether the maintenance intervals for devices are being adhered to. The checking unit may be installed or integrated in the device requiring to be checked. The checking unit can be provided a signal for taking the device out of service if the validity check produces a negative result. The device can either be directly deactivated by the signal or the need to take it out of service being indicated acoustically or visually. The device can be switched over to an emergency operation in response to the signal in order to avoid operational disruptions caused by immediate deactivation and the ensuing adverse consequences. The validity check can also be embodied such that notice is given an appropriately selected time ahead of when the next due maintenance begins.

The check can also be made dependent on other information so that alongside the time information or time period, further maintenance or certification-related information is taken into account, for example, an interrogated code assigned to the issuer of the RFID label, by which the correctness of the information stored on the RFID label is checked.

An RFID transponder can be supplied with an item of time information for a validity check performed by the checking unit, and to a system including an RFID transponder of the type and a checking unit.

### BRIEF DESCRIPTION OF THE DRAWINGS

FIG. 1 shows one embodiment of a checking unit in the case of which an RFID label is located directly on an RFID reader, and

FIG. 2 shows one embodiment of a checking unit in the case of which an RFID label is located in the proximity of an RFID reader.

### DETAILED DESCRIPTION

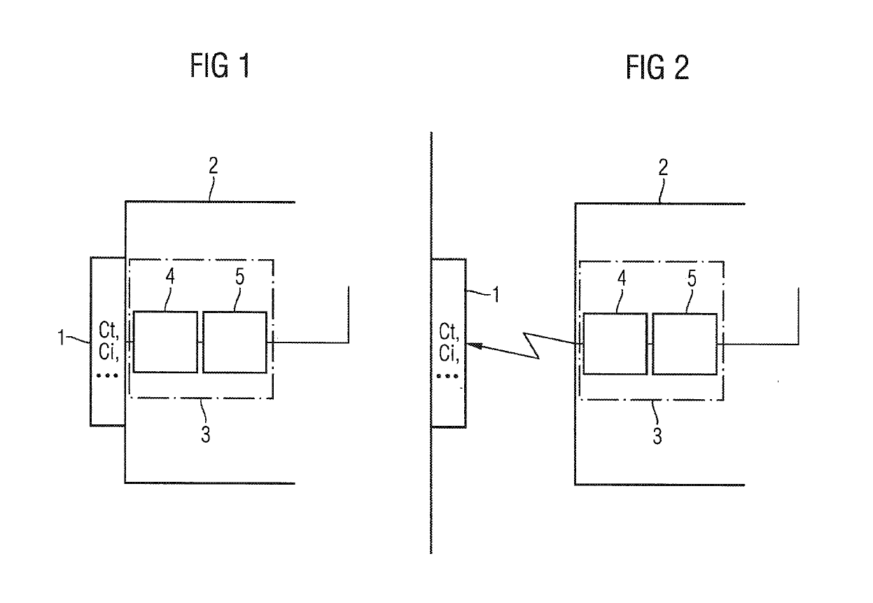

FIGS. 1-2 show an RFID label 1 (test, service, or maintenance label) containing a code Ct that can be assigned to a specific expiration date and a code Ci assigned to an issuer of the RFID label 1. Further codes such as, for example, a company-related code, a code relating to a service or test interval, a code relating to a service engineer, or any combinations thereof are likewise conceivable and expedient depending on the specific constellation. The label 1 is secured to a device 2. The device 2 can be a device requiring to be checked or maintained, for example, a water-treatment system, a transformer substation generator, an atomic power station generator, a motor, etc. The device 2 can include an integrated checking unit 3 which includes an RFID reader 4 and a control unit 5. It is alternatively conceivable for the checking unit 3 to be located separately from the machine being checked, for example, to be integrated in a controlling device or controlling unit. Any device 2 including objects such as lathes, mortising machines, or grinding machines that do not lend themselves to being fitted directly with the checking unit 3 can be controlled with a checking unit 3 that is located separately. The information will then be read, for example, at regular intervals from the RFID labels and a validity check performed. If the result is negative, the relevant device 2 will, for example, be automatically deactivated. It will be put into operation again, for example, through a service engineer's or service company's performing a maintenance operation and replacing the RFID label 1 with a new label. When the device 2 taken out of operation is restarted, the information on the new label will then be read and a check will indicate that the label has been produced by one of the designated checking services and that operating the device again until the set operating period expires has a green light.

The RFID label 1 can be located directly on the RFID reader 4 (FIG. 1) or readably in the proximity of the RFID reader 4 (FIG. 2).

The subject of the invention is not restricted to the facts described in the exemplary embodiment. An inventive checking unit can be employed for any technical devices as will be directly apparent to a person skilled in the relevant art from the description.

Various embodiments described herein can be used alone or in combination with one another. The foregoing detailed description has described only a few of the many possible implementations of the present invention. For this reason, this detailed description is intended by way of illustration, and not by way of limitation. It is only the following claims, including all equivalents that are intended to define the scope.

1. A checking unit, comprising
an RFID reader and
a control unit,
wherein the control unit is embodied for performing a validity check that relates to a time period and is based on time information read by the RFID reader from an RFID label and conveyed to the control unit.

2. The checking unit as claimed in claim 1, wherein the checking unit is integrated in a device.

3. The checking unit as claimed in claim 2, wherein the checking unit sends a signal for taking the device out of operation if the validity check produces a negative result.

4. The checking unit as claimed in claim 3, wherein the device is taken out of operation directly by the signal or the lack of at least one operational prerequisite will be indicated acoustically or visually by the signal.

5. The checking unit as claimed in claim 1, wherein the validity check is performed on the basis of a plurality of items of information read by the RFID reader from the RFID label and conveyed to the control unit.

6. An RFID label comprising:
a storage device that stores at least one item of time information for a validity check; and
means for attaching the RFID label to a device.

7. The RFID label as claimed in claim 6, wherein the RFID label includes a plurality of items of information for use for the validity check.

8. A checking system, comprising:
an RFID label on which is stored at least one item of time information relating to a validity period, and
having a checking unit comprising an RFID reader and a control unit, wherein the control unit is embodied for performing a validity check that relates to a time period and is based on time information read by the RFID reader from an RFID label and conveyed to the control unit.

9. A method for checking a validity of a time-limited status of a device, the method comprising:
reading at least one item of time information relating to a validity period from an RFID label by an RFID reader of a checking unit, and
checking, using a control unit of checking unit, the time-limited status using the time information.

10. The method as claimed in claim 9, wherein the time-limited status relates to a time period during which a device can be operated without having to be checked.

11. The method as claimed in claim 9, wherein the time information is a time when a device needs further checking or maintenance.

12. The method as claimed in claim 9, wherein the time information is a length of time for which a device's function check is valid.

13. The method as claimed in claim 9, wherein checking includes checking to determine whether maintenance is due again.

14. The method as claimed in claim 9, wherein checking includes checking, in a case of certification or confirmation of the functional status, whether the relevant time period has or has not expired.

15. The method as claimed in claim 9, wherein reading the time information and checking the validity can be performed at regular intervals.

16. The method as claimed in claim 15, wherein the regular intervals relate to operations performed on the device being examined.

17. The method as claimed in claim 16, wherein the operations include power-up or cutover.

18. The method as claimed in claim 16, wherein the time information takes the operations into account and delimits the length of the interval between individual checks by an electronic operating-hours counter or start-up counter.
